(19) United States
(12) Patent Application Publication
(10) Pub. No.: US 2020/0177124 A1
(43) Pub. Date: Jun. 4, 2020

(54) LIGHT SOLAR PANEL FOR SMALL SATELLITES

(71) Applicant: Universite De Montpellier, Montpellier (FR)

(72) Inventors: Vasily MURAVYEV, Moscow (RU); Laurent Dusseau, Saint Gely Du Fesc (FR)

(21) Appl. No.: 16/305,014

(22) PCT Filed: May 24, 2017
(86) PCT No.: PCT/EP2017/062611

§ 371 Date: Nov. 27, 2018

(30) Foreign Application Priority Data
May 27, 2016 (EP) 16305623.7

(51) Int. Cl. H02S 30/10; C08F 10/02; C08G 69/26

(52) U.S. Cl. CPC H02S 30/10; C08G 69/26; C08F 10/02

(57) ABSTRACT

A solar panel (12) that comprise at least one photovoltaic cell (14) fixed on a support (16) comprising a frame (18). The support (16) comprises guiding means and a continuous wire (20), the wire (20) being strung on the frame (18) by being hooked on the guiding means, the photovoltaic cell (14) being fixed on the wire (20).

The present invention relates to the field of solar panels, in particular solar panels for small-sized satellites, e.g. CubeSat class satellites.

A CubeSat is a type of miniature satellite made-up of 10×10×11.35 cm cubical units the mass of which is limited to 1.33 kg per units.

In the current state of the art, solar panels for small sized satellites comprising a support plane, made of aluminum alloy or plastic, and solar cells are known. In these solar panels, the solar cells are glued to the support plane, or fixed by other fixing means. Such solar panels also comprise a frame that reinforces the support plane.

The mass is an important parameter for a satellite, and especially for CubeSat-class satellites. The limitation of the mass is very strict and thus, to lower the mass of any part of a satellite is an important improvement.

The goal of this invention is to provide a light solar panel suitable for small sized satellites.

Accordingly, the invention is directed to a solar panel comprising at least one photovoltaic cell fixed on a support comprising a frame, characterized in that the support comprises guiding means and a continuous wire, the wire being strung on the frame by being hooked on the guiding means, the photovoltaic cell being fixed on the wire.

The wire that supports the solar cell is a lighter support element compared to the support plane known in the state of the art. Thus the invention provides an overall lighter solar panel.

A solar panel according to the invention also allows for an improvement of the thermal response of the solar panel. The use of a wire also allows to adjust the rigidity of the support of the solar panel more easily.

Additionally, the solar panel according to the invention may comprise any of the following characteristics:
the wire is made of plastic material e.g. polyethylene or nylon.
the photovoltaic cell is glued to the wire;
the photovoltaic cell is fixed on parts of the wire that are flushed with a common geometric plane;
the solar panel comprises sections of the wire extending essentially in a first and a second directions, the first and second directions being different, the parts of the wire that are flushed with the common geometric plane being formed by sections of the wire extending in the second direction;
the sections of the wire extending in the first direction are intertwined with the sections of the wire extending in the second direction, in such a way that the wire forms a net comprising meshes, delimited by sections of the wire extending in the first and in the second directions;
the perimeter of a mesh is at least 40 times longer than the diameter of any of the sections of the wire delimiting it, and preferably from 64 to 320 times longer;
a section of the wire extending in the second direction comprises at least a loop wrapped around a section of the wire extending in the first direction;
the sections of the wire extending in the first direction contact the frame on a first surface and the sections of the wire extending in the second direction contact the frame on a second surface, the first and the second surfaces being parallel and offset, the offset corresponding essentially to the diameter of the wire;
the frame is made of at least a material selected among metallic alloys, polymers and composite materials;
the frame has an essentially polygonal shape the sides of which are delimited by supporting elements having essentially rectangular sections, the frame also comprises at least a reinforcement element of the frame;
an extremity of the wire is assembled with the frame by being wound around one of the supporting elements;
the frame has a rectangular shape, the supporting elements of the frame extending in the first or the second directions;
the extremity of the wire is wound around two adjacent supporting elements of the frame;
a supporting element comprises two opposite lateral faces parallel to the sides of the frame and two opposite faces perpendicular to the lateral faces, delimiting the inner and outer outlines of the frame, and wherein the guiding means are located on the outer face of the supporting elements, the wire comprising hooked sections which are hooked in the guiding means and in contact with the supporting elements, the hooked sections being in contact with at least a lateral face of the supporting element and the outer face of the supporting element;
a supporting element comprises two opposite lateral faces parallel to the sides of the frame and two opposite faces perpendicular to the lateral faces, delimiting the inner and outer outlines of the frame, and wherein the guiding means are located on the inner face of the supporting elements, the wire comprising hooked sections which are hooked in the guiding means and in contact with the supporting elements, the hooked sections being in contact with all the lateral, inner and outer faces of the supporting element;
the support comprises glue that links at least two sections of the wire together or that link the wire to the frame.

The invention, however, may be better understood by reference to the following description taken in conjunction with the accompanying drawing figures in which:

FIG. 1 is a perspective view of a solar panel according to a first embodiment of the invention,

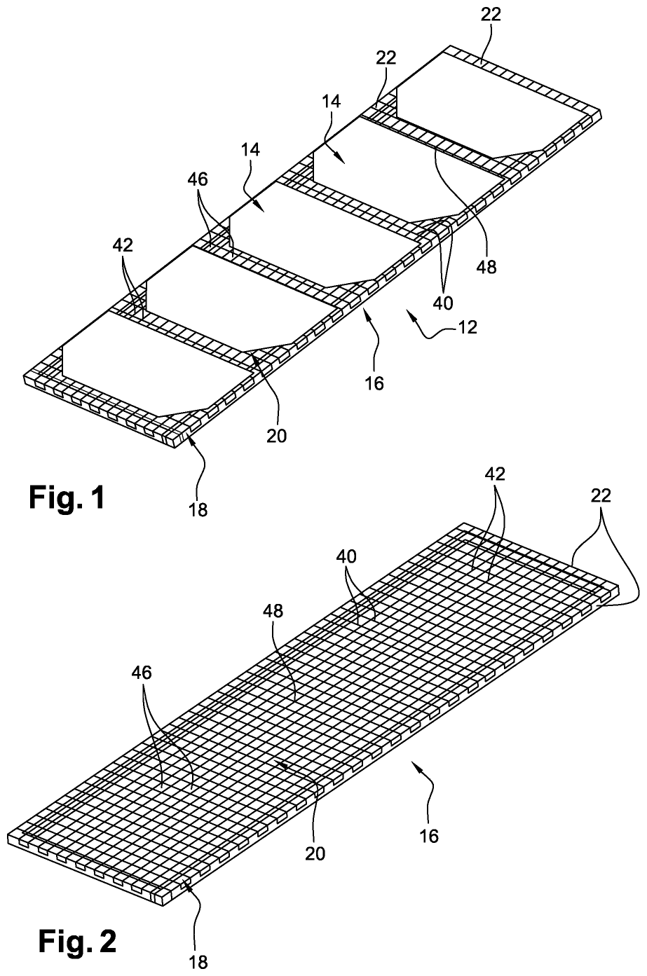

FIG. 2 is a perspective view of a support of the solar panel represented on FIG. 1,

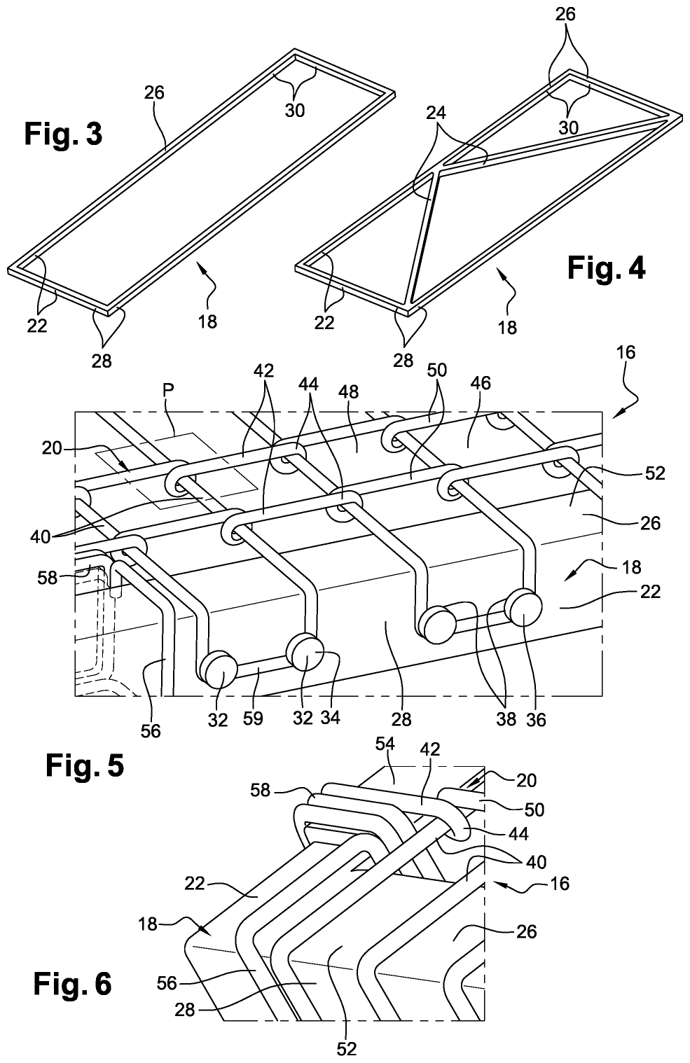

FIGS. 3 and 4 are perspective views respectively of a frame of the solar panel represented on FIG. 1 and of a variant of this frame,

FIGS. 5 and 6 are perspective views of details of the support represented on FIG. 2,

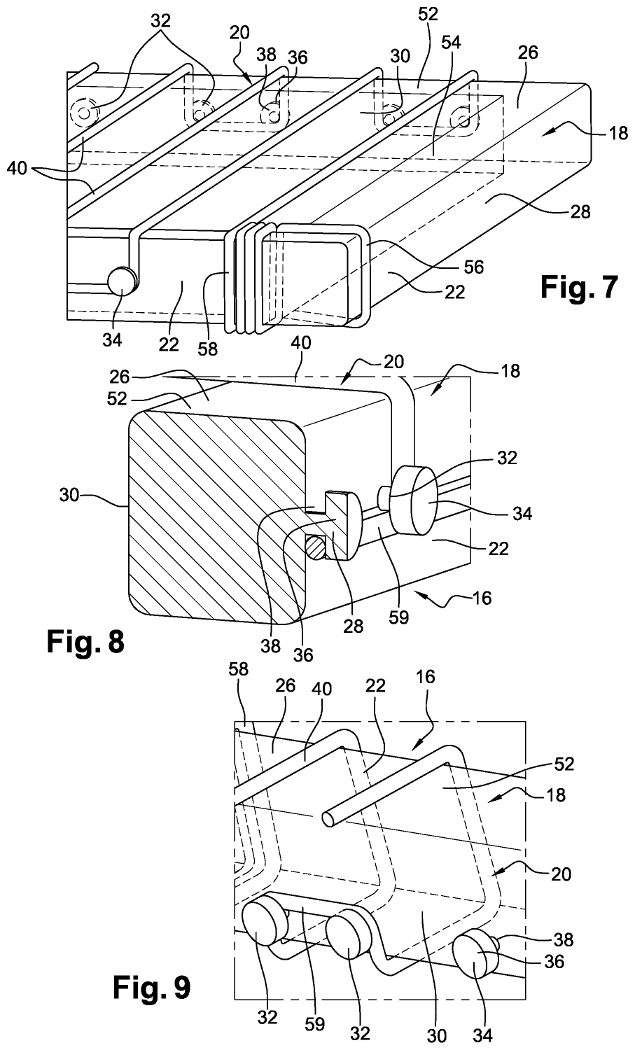

FIG. 7 is a perspective view of the support represented in FIG. 2, during a step of its manufacturing while a continuous wire is being strung on it,

FIG. 8 is a cross section of a perspective view showing a detail of the support represented on FIG. 2,

FIG. 9 is a perspective view showing a detail of a variant of the support represented FIG. 2,

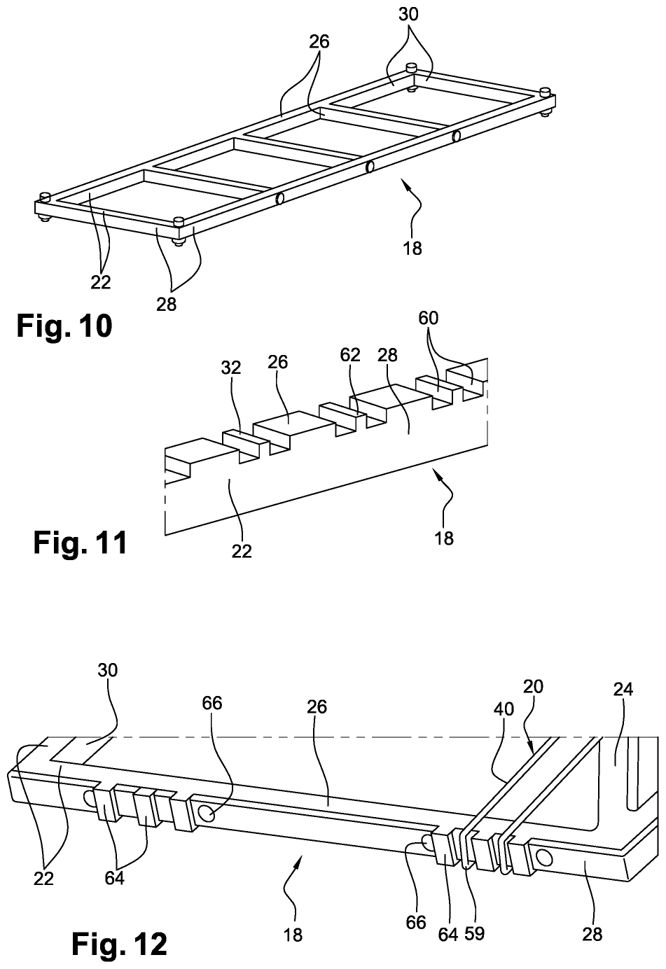

FIG. 10 is a perspective view of a frame of a support of a solar panel according to a second embodiment of the invention,

FIG. 11 is a perspective view of a detail of the frame represented on FIG. 10,

FIG. 12 is a perspective view of a detail of a variant of the frame of the solar panel represented on FIG. 1.

Referring to FIGS. 1-9 of the drawings, there is shown a deployable solar panel 12 for a 3-unit CubeSat-class satellite according to a first embodiment of the invention. This embodiment of the invention is given as an example.

The solar panel 12 comprises five photovoltaic cells 14 fixed on a support 16. The support 16 comprises a frame 18, represented on FIG. 3, on which a wire 20 is strung. The support 16 has essentially the shape of a parallelepiped the dimensions of which are inferior to 83 mm×300 mm×6 mm.

The frame 18 has essentially a polygonal shape, more particularly a rectangular shape. The sides of the frame 18 are delimited by supporting elements 22. The supporting elements 22 are hollow beams having a rectangular section. Alternatively, beams with a circular section or a section with a different shape known in the art are suitable. Alternatively, the frame 18 can have reinforcement elements 24 of the frame as represented on FIG. 4. The reinforcement elements 24 are arranged in such a way that they increase the rigidity of the frame 18. The means for assembling different elements 22, 24 of the frame 18 together are known of the one skilled in the art and can include for example welding or bolting. The sides of the frame extend in a first and in a second directions perpendicular to each other.

The frame 18 is made of a material selected among metallic alloys, polymers and composite materials.

Each supporting element 22 comprises two opposite faces 26 that are parallel to the sides of the frame 18 and two opposite faces 28, 30, called inner face 28 and outer face 30, perpendicular to the lateral faces 26 delimiting the inner and outer outline of the frame 18.

The frame 18 comprises guiding means 32, represented on FIGS. 5, and 7-9. These guiding means 32 are located on the outer faces 28 of the supporting elements 22. Each guiding means 32 comprise a pair of appendages 34 around which the wire 20 is hooked. The appendage 34 comprises a solid cylinder 36 on which a circumferential groove 38 is arranged. The wire 20 is hooked in the circumferential groove 38. Alternatively, the guiding means 32 are located on the inner face 30 of the supporting elements 22, as represented on FIG. 9.

The wire 20 strung on the frame is made of a single continuous wire. A continuous wire can be made of:
a single uninterrupted fiber comprising exactly two extremities 39 and extending from one extremity 39 of the wire 20 to the other extremity 39 of the wire 20, or
or several uninterrupted fibers each comprising two extremities, the extremity of the fibers being linked together two by two, by means of knotting for example, to form the continuous wire, in such a way that two extremities of fibers which are not linked to any other extremity form the two extremities 39 of the wire 20.

The wire 20 is preferably made of plastic material, e.g. polyethylene or nylon, but any other suitable material can be used. The wire can be made of a single fiber or made of different fibers woven together.

The wire 20 comprises sections 40 extending essentially in the first direction and sections 42 extending essentially in the second direction. The sections 42 of the wire 20 extending in the second direction comprise loops 44 wrapping around the sections 40 of the wire 20 extending in the first direction Thus the sections 42 extending in the second direction are intertwined with the sections 40 extending in the first direction and the wire 20 forms a net 48 comprising meshes 46, delimited by sections 40, 42 of the wire 20 extending in the first and in the second directions.

The dimensions of the meshes 46 and the diameter of the wire 20 are chosen in such a way that the net 48 forms an essentially plane network having large meshes. The perimeter of the meshes 46 is at least 40 times longer than the diameter of the wire 20. Preferably, the diameter of the wire 20 ranging from 0.1 mm to 0.25 mm, and the meshes 46 are generally rectangular and their sides have a length ranging from 4 mm to 8 mm. Thus the perimeter of the meshes 46 is from 64 to 320 times longer than the diameter of the wire 20, depending on the chosen dimensions for the wire 20 and the meshes 46.

The sections 42 of the wire 20 extending in the second direction comprise parts 50 of the wire 20 extending between the loops 44 of the sections 42 of the wire 20. These parts 50 are flushed with a common geometric plane P, the section 40, 42 of wire extending in a volume being bounded by the plane P. The photovoltaic cells 14 are fixed on this plane P. The photovoltaic cells 14 are fixed by being glued to the parts 50.

The sections 40 of the wire 20 extending in the first direction contact the frame 18 on first surfaces 52 formed by lateral faces 26 of the supporting elements 22. The sections 42 of the wire 20 extending in the second direction contact the frame 18 on second surfaces 54 formed by lateral faces 26 of the supporting elements 22. The first and the second surfaces 52, 54 are parallel and offset, the offset corresponding essentially to the diameter of the wire 20 (see FIG. 6). This offset allows the sections 42 of the wire 20 extending in the second direction and in contact with the second surfaces 54 to be flushed with the common geometric plane P.

The extremities 39 of the wire 20 are fixed to the frame 18 by being wound around the supporting elements 22. The wire 20 is wound in such a way that a primary loop 56 is made around one supporting element 22 and secondary loops 58 are made around an adjacent supporting element 22 (see FIG. 7).

Starting from an extremity 39 of the wire 20, the wire 20 comprises:
first, one primary loop 56 around a first supporting element 22,
then, several secondary loops 58 around a second supporting element 22 adjacent to the first supporting element 22,
then, a section 40 or 42 of the wire extending essentially in the direction of the first supporting element 22.

The wire 20 comprises hooked sections 59 which are hooked in the guiding means 32 and in contact with the supporting elements 22. Each hooked section 59 of the wire 20 is in contact with a lateral surface 26 and an outer surface 28 of a supporting element 22. In the variant represented on FIG. 9, each hooked section 59 is in contact with all four faces (the two lateral faces 26, the outer 28 and the inner 30 faces) of a supporting element 22.

Different sections of the wire 20 that are in contact with each other may be glued together. By choosing to glue or not to glue different parts of the solar panel 12, it is possible to influence the thermal behavior of the solar panel 12. For example, it is possible to glue two sections of wire 20 together only if none of these sections are glued to a solar cell 14 in order to limit the diffusion of the heat in the support 16.

The solar panel according to the invention may be mounted on a satellite using fixing means known in the art.

FIGS. 10 and 11 represent a second embodiment of the invention. In these figures, the elements similar to those of the preceding figures are designated by identical references. The frame 18 is a plane beam structure, the different elements 22, 24 of the frame 18 being linked together by means of bolts and screws. Each guiding means 32 comprise two grooves 60 arranged on a lateral face 26 of a supporting element 22. Between these two grooves 60, there is an appendage 62 on which the wire 20 is hooked.

On FIG. 12, a variant of the frame 18 of the solar panel 12 according to the first embodiment of the invention is shown. In this embodiment, the guiding means 32 are located on the lateral face 26 of the supporting elements 22 and are not visible on FIG. 12. A supporting element 22 represented on FIG. 12 comprises spacers 64 and fixing holes 66. This supporting element 22 is intended to be attached to a support of the satellite (not represented) by means of bolts or any other means known in the art arranged in the fixing hole 66. The spacers 64 are located on the outer face 28 of the supporting element 22 and are intended to be in contact with the support of the satellite. The spacers 64 are thick enough to allow the hooked sections 59 of the wire 20 extending on the outer surface 28 of the supporting element 22 to extend between the outer surface 28 and the support of the satellite without being in contact with the support of the satellite. Thus, the wire cannot be damaged by being crushed between the support of the satellite and the supporting element 22.

The invention is not limited to the embodiments represented on the figures and other embodiments of the invention would be obvious for the one skilled in the art. It would be possible to string additional fiber on the frame, extending essentially in the first direction, these fibers forming the parts that are glued to the solar cells.

Further, the invention is not limited to the field of space engineering.

1. Solar panel comprising at least one photovoltaic cell fixed on a support frame, which support comprises guiding means and a continuous wire, the wire being strung on the frame by being hooked on the guiding means, the photovoltaic cell being fixed on the wire.

2. Solar panel according to claim 1, wherein the wire is made of plastic material.

3. Solar panel according to claim 1, wherein the photovoltaic cell is glued to the wire.

4. Solar panel according to claim 1, wherein the photovoltaic cell is fixed on parts of the wire that are flush with a common geometric plane.

5. Solar panel according to claim 4, comprising sections of the wire extending essentially in a first and a second directions, the first and second directions being different, the parts of the wire that are flush with the common geometric plane being formed by sections of the wire extending in the second direction.

6. Solar panel according to claim 5, wherein the sections of the wire extending in the first direction are intertwined with the sections of the wire extending in the second direction, in such a way that the wire forms a net comprising meshes, delimited by sections of the wire extending in the first and in the second directions.

7. Solar panel according to claim 6, wherein the perimeter of a mesh is at least 40 times longer than the diameter of any of the sections of the wire delimiting it, and preferably from 64 to 320 times longer.

8. Solar panel according to claim 6, wherein at least a section of the wire extending in the second direction comprises at least a loop wrapped around a section of the wire extending in the first direction.

9. Solar panel (12) according to claim 5, wherein the sections of the wire extending in the first direction contact the frame on a first surface and the sections of the wire extending in the second direction contact the frame on a second surface the first and the second surfaces being parallel and offset, the offset corresponding essentially to the diameter of the wire.

10. Solar panel according to claim 1, wherein the frame is made of at least a material selected from the group consisting of metallic alloys, polymers and composite materials.

11. Solar panel according to claim 1, wherein the frame has an essentially polygonal shape the sides of which are delimited by supporting elements having essentially rectangular sections, the frame also comprises at least a reinforcement element of the frame.

12. Solar panel according to claim 11, wherein an extremity of the wire is assembled with the frame by being wound around one of the supporting elements.

13. Solar panel according to claim 11, wherein the frame has a rectangular shape, the supporting elements of the frame extending in the first or the second directions.

14. Solar panel according to claim 11, wherein the extremity of the wire is wound around two adjacent supporting elements of the frame.

15. Solar panel according to claim 11, wherein a supporting element comprises two opposite lateral faces parallel to the sides of the frame and two opposite faces perpendicular to the lateral faces, delimiting the inner and outer outlines of the frame, and wherein the guiding means are located on the outer face of the supporting elements, the wire comprising hooked sections which are hooked in the guiding means and in contact with the supporting elements, the hooked sections being in contact with at least a lateral face of the supporting element and the outer face of the supporting element.

16. Solar panel according to claim 11, wherein a supporting element comprises two opposite lateral faces parallel to the sides of the frame and two opposite faces perpendicular to the lateral faces, delimiting the inner and outer outlines of the frame, and wherein the guiding means are located on the inner face of the supporting elements, the wire comprising hooked sections which are hooked in the guiding means and in contact with the supporting elements, the hooked sections being in contact with all the lateral, inner and outer faces of the supporting element.

17. Solar panel according to claim 1, wherein the support comprises glue that links at least two sections of the wire together or that link the wire to the frame.

18. Solar panel according to claim 1, wherein the wire is made of polyethylene or nylon.
